(19) United States
(12) Patent Application Publication
(10) Pub. No.: US 2011/0214550 A1
(43) Pub. Date: Sep. 8, 2011

(54) Punching Device

(76) Inventor: Chung-Yi Lee, New Taipei City (TW)

(21) Appl. No.: 13/024,852

(22) Filed: Feb. 10, 2011

(30) Foreign Application Priority Data
Mar. 8, 2010 (TW) 099204033

(51) Int. Cl. B26D 5/08

(52) U.S. Cl. 83/625

(57) ABSTRACT

A punching device includes: a base unit including a supporting part having two opposite pivot seats and a die part; a punch unit including a punch that is disposed directly above the die part and between the pivot seats, the punch being slidable against the die part along a vertical axis; and a pressing unit including two driving levers, each of which has a driving protrusion. The driving protrusions of the driving levers are disposed located respectively to two sides of the vertical axis in asymmetrical manner with respect to the vertical axis and are rotatable relative to the base unit to press against the punch unit.

### CROSS-REFERENCE TO RELATED APPLICATION

This application claims priority of Taiwanese Application No. 099204033, filed on Mar. 8, 2010.

### BACKGROUND OF THE INVENTION

1. Field of the Invention

This invention relates to a punching device, more particular to a punching device including a pair of driving levers for driving a punch to slide against a die for cutting a sheet.

2. Description of the Related Art

Referring to FIG. 1, Taiwanese Patent Application No. 81203592 discloses a conventional punching device 100 that is used in the craft industry for cutting a sheet (not shown), such as a paper sheet and a plastic sheet, in a predetermined pattern to form a craft article. The punching device 100 includes a base 11, a punch 12, a compression spring 13, a pressing button 14, and a cap 15. The base 11 includes a bottom plate 111 and a supporting plate 112 parallel to and connected to the bottom plate 111 and cooperating with the bottom plate 111 to define a gap 10 for extension of the sheet therein. The bottom plate 111 is formed with a die hole 113 for passage of the punch 12 therethrough. The pressing button 14 is seated on the punch 12 for pressing the punch 12 against the compression spring 13 so as to move the punch 12 along a vertical axis (X) into and through the die hole 113 in the bottom plate 111, thereby cutting the sheet. The compression spring 13 restores the punch 12 to its original position after punching. The cap 15 covers the punch 12 and the supporting plate 112 and is formed with a top opening for extension of the pressing button 14 therethrough. Since the force acted on the pressing button 14 is directly transmitted to the punch 12 in the vertical axis (X), it is laborious when using the aforesaid punching device to cut a thick sheet.

Referring to FIG. 2, U.S. Pat. No. RE38219 discloses a punching device 200 including a base 21, a punch 22, a compression spring unit 23, a cap 24 and a pressing lever 25. The base 21 has a bottom plate 211 and a supporting plate 212 disposed above and connected to the bottom plate 211 through a connecting wall 217 and cooperating with the bottom plate 211 to define a gap 213 therebetween for receiving a sheet (not shown) therein. The bottom plate 211 is formed with a die hole 214. The supporting plate 212 has one end provided with a pivot seat 216, and is formed with a through-hole 215 aligned with the die hole 214 for extension of the punch 22 therethrough and into the die hole 214. The punch 22 has a bottom blade edge 221 for cutting the sheet. The compression spring unit 23 abuts against the supporting plate 212 and the punch 22 for restoring the punch 22 to its original position. The pressing lever 25 has a pivot end 251 pivoted to the pivot seat 216, a pressing end 253 opposite to the pivot end 251, and a driving protrusion 252 that is disposed between the pivot end 251 and the pressing end 253 and that is aligned with the punch 22 along a vertical axis (Y) perpendicular to the sheet. When the pressing end 253 of the pressing lever 25 is pressed, the driving protrusion 252 presses the punch 22 to move along the vertical axis (Y) into and through the die hole 214, thereby cutting the sheet.

Although the pressing lever 25 of the punching device 200 permits a less force required to punch the sheet as compared to the previous conventional punching device 100, it undesirably and considerably increases the length of the punching device 200 attributed to the length of the pressing lever 25. Moreover, according to the lever principle, the shorter the distance between the pivot end 251 (fulcrum) and the driving protrusion 252 (load) and the longer the distance between the pivot end 251 and the pressing end 253 (effort), the more will be the mechanical advantage, i.e., the less effort is required. Since the contact between the driving protrusion 252 and the punch 22 is required to be located on the vertical axis (Y) in order to prevent imbalance problem for the punch 22 (inclination of the punch 22 or uneven movement of the punch 22) from occurring, the distance between the pivot end 251 and the driving protrusion 252 is fixed and cannot be reduced. As a consequence, the longer the distance between the pivot end 251 and the driving protrusion 252, the longer the distance between the pivot end 251 and the pressing end 253 is required to maintain the same effort. In addition, since the pressing end 253 of the pressing lever 25 is located at one side of the punch device 200 and is relatively far from the vertical axis (Y), the dimensions of the base 21 are required to be enlarged in order to increase the stability of the punch device 200 and to prevent the punch device 200 from raising up or flipping over upon pressing of the pressing end 253, thereby further increasing the overall size of the punch device 200.

### SUMMARY OF THE INVENTION

Therefore, an object of the present invention is to provide a punching device that can easily punch a sheet without increasing the size of the punching device as encountered in the prior art.

According to the present invention, there is provided a punching device for cutting a sheet. The punching device comprises: a base unit including a supporting part having two opposite pivot seats, and a die part connected to the supporting part for supporting the sheet thereon; a punch unit including a punch that is disposed between the pivot seats, the punch unit being supported movably on the base unit so that the punch is slidable against the die part along a vertical axis substantially perpendicular to the sheet for cutting the sheet; and a pressing unit including two driving levers, each of which has a pivot end pivoted to a respective one of the pivot seats, a pressing end opposite to the pivot end, and a driving protrusion disposed between the pivot end and the pressing end and protruding therefrom toward the punch unit. The vertical axis is disposed between the driving protrusions of the driving levers. The driving protrusions of the driving levers are disposed in a symmetrical manner with respect to the vertical axis and are rotatable relative to the base unit to press against the punch unit to drive movement of the punch unit along the vertical axis toward the base unit for cutting the sheet when the pressing ends of the driving levers are pressed to move toward the base unit.

### BRIEF DESCRIPTION OF THE DRAWINGS

In drawings which illustrate embodiments of the invention,

FIG. 1 is a sectional view of a conventional punching device;

FIG. 2 is a sectional view of another conventional punching device;

FIG. 3 is an exploded perspective view of the first preferred embodiment of a punching device according to this invention;

FIG. 4 is a sectional view of the first preferred embodiment, illustrating a state where a pressing unit is disposed at an original position;

FIG. 5 is a sectional view of the first preferred embodiment, illustrating another state where the pressing unit is disposed at a punching position;

FIG. 6 is a fragmentary top view of the first preferred embodiment, a cap being removed to illustrate the structure of the driving levers;

FIG. 7 is an exploded perspective view of the second preferred embodiment of a punching device according to this invention;

FIG. 8 is a fragmentary top view of the third preferred embodiment of a punching device according to this invention; and

FIG. 9 is a fragmentary top view of the fourth preferred embodiment of a punching device according to this invention.

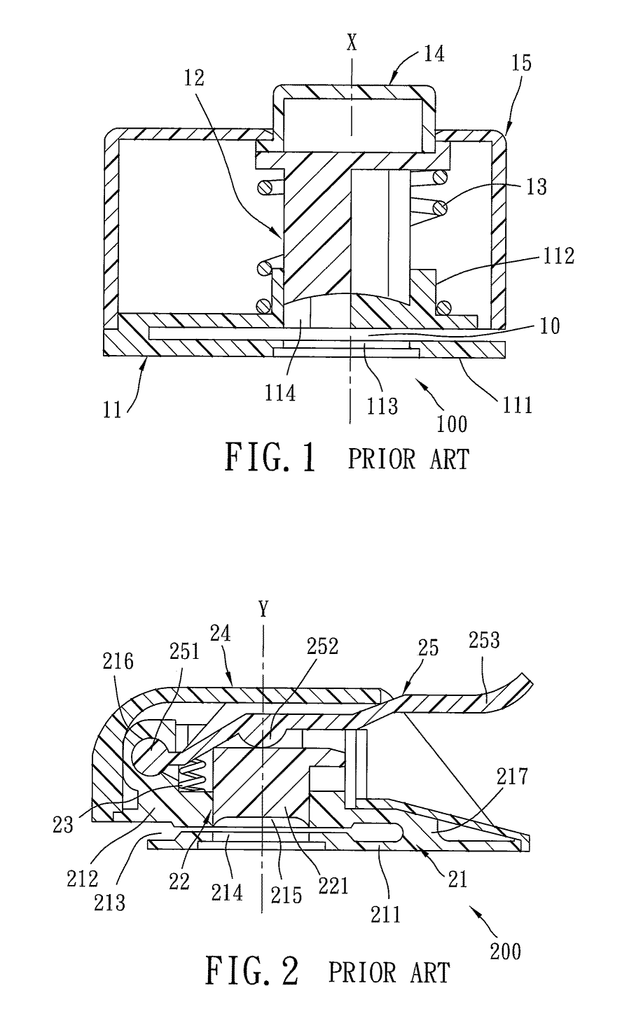

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

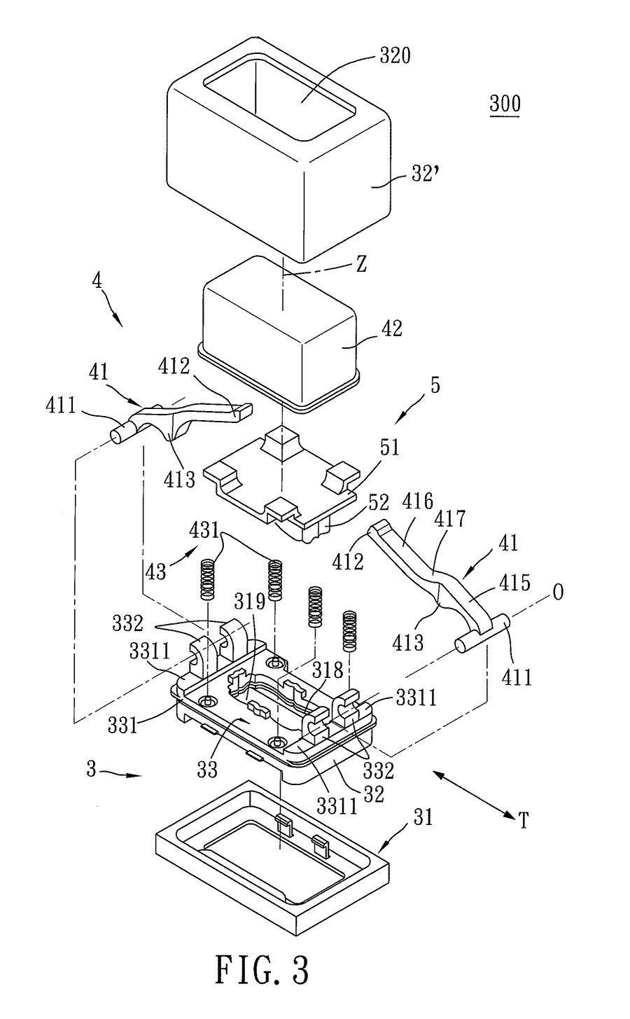

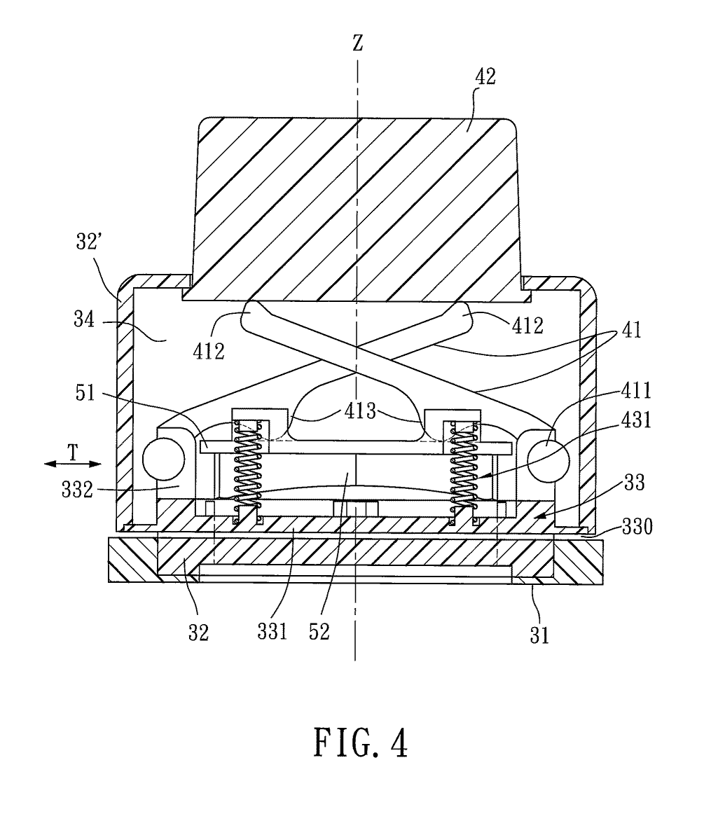

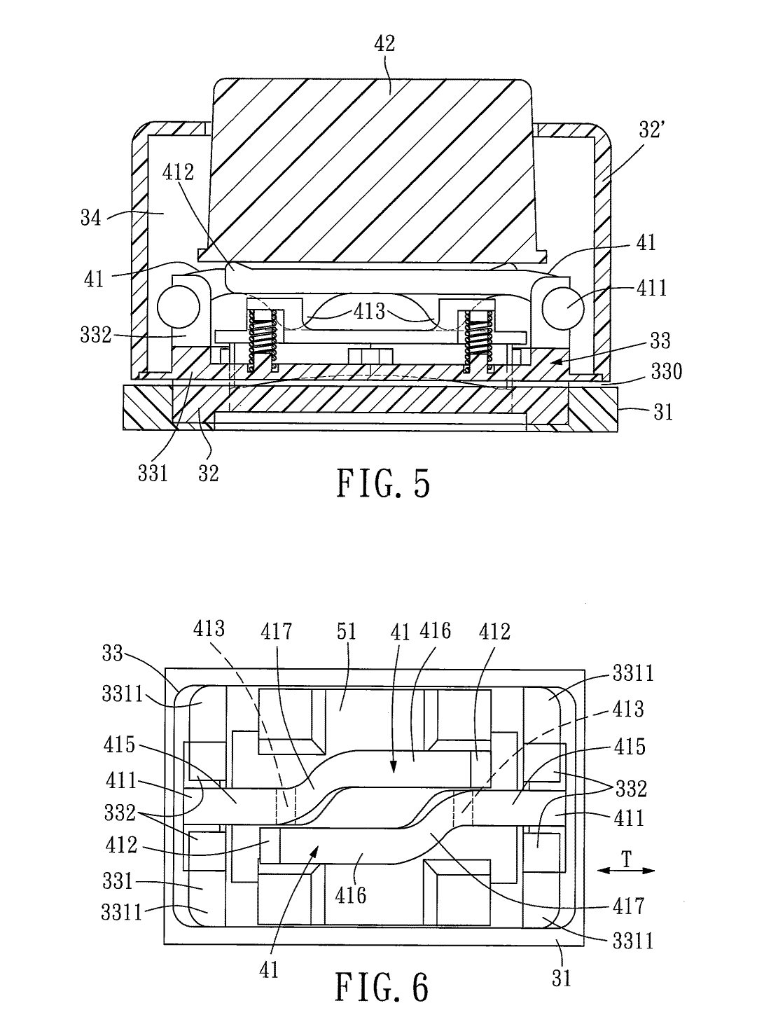

Referring to FIGS. 3 and 4, the first preferred embodiment of a punching device 300 for cutting a sheet (not shown) according to the present invention is shown to include: a base unit 3 including a base frame 31, a supporting part 33 connected to the base frame 31 and having two pivot seats 332 that are opposite to each other in a transverse direction (T), and a die part 32 connected to the supporting part 33 for supporting the sheet (not shown) thereon, each of the pivot seats 332 having a pair of C-shaped hooks; a punch unit 5 including a punch head 51 and a punch 52 extending downwardly from the punch head 51 and disposed directly above the die part 32 and between the pivot seats 332, the punch unit 5 being supported movably on the base unit 3 so that the punch 52 is slidable against the die part 32 along a vertical axis (Z) substantially perpendicular to the sheet for cutting the sheet; and a pressing unit 4 including two driving levers 41, each of which has a pivot end 411, a pressing end 412 opposite to the pivot end 411, and a driving protrusion 413. The pivot end 411 is pivoted to the C-shaped hooks of a respective one of the pivot seats 332 of the supporting part 33 so that the pressing unit 4 is rotatable relative to the base unit 3 about a rotation axis (O) between an original position (FIG. 4) and a punching position (see FIG. 5). The driving protrusion 413 of each of the driving levers 41 is disposed between the pivot end 411 and the pressing end 412, and protrudes therefrom toward the punch unit 5. The vertical axis (Z) is disposed between the driving protrusions 413 of the driving levers 41. The driving protrusions 413 of the driving levers 41 are disposed respectively at two sides of the vertical axis (Z) in a symmetrical manner with respect to the vertical axis (Z), and are rotatable relative to the base unit 3 to press against the punch unit 5 to drive movement of the punch unit 5 along the vertical axis (Z) toward the base unit 3 for cutting the sheet when the pressing ends 412 of the driving levers 41 are pressed to move toward the base unit 3.

The supporting part 33 further has a frame portion 331 that is generally rectangular in shape, that has four corners 3311, that is disposed directly above and that is connected to the die part 32 at one end thereof, and that defines a frame hole 318 for extension of the punch 52 therethrough. The supporting part 33 cooperates with the die part 32 to define a gap 330 therebetween for extension of the sheet therein. Each of the pivot seats 332 is formed on the frame portion 331, and is disposed at a middle position between two adjacent ones of the corners 3311. The die part 32 has a die hole 319 for extension of the punch 52 therethrough.

An urging unit 43 includes a plurality of compression springs 431 extending between and abutting against the supporting part 33 and the punch head 51 of the punch unit 5 so that the urging unit 43 can be compressed by the punch unit 5 to accumulate a restoring force for restoring the punch unit 5 to its original position.

Referring to FIG. 6, in combination with FIGS. 3 and 4, the driving levers 41 cross the vertical axis (Z) and are disposed in a symmetrical manner. Each of the driving levers 41 is slightly S-shaped and includes first and second end segments 415, 416 that define the pivot end 411 and the pressing end 412, respectively, and a middle segment 417 bent from the first and second end segments 415, 416 so that the first and second end segments 415, 416 are offset from each other.

The pressing unit 4 further includes a pressing member 42 seated on the pressing ends 412 of the driving levers 41 for depressing the pressing ends 412 of the driving levers 41 along the vertical axis (Z). A cap 32′ is mounted on the base unit 3, defines an accommodating space 34 for receiving the driving levers 41, the punch unit 5 and the supporting part 33 therein, and is formed with a top opening 320 for extension of the pressing member 42 therethrough.

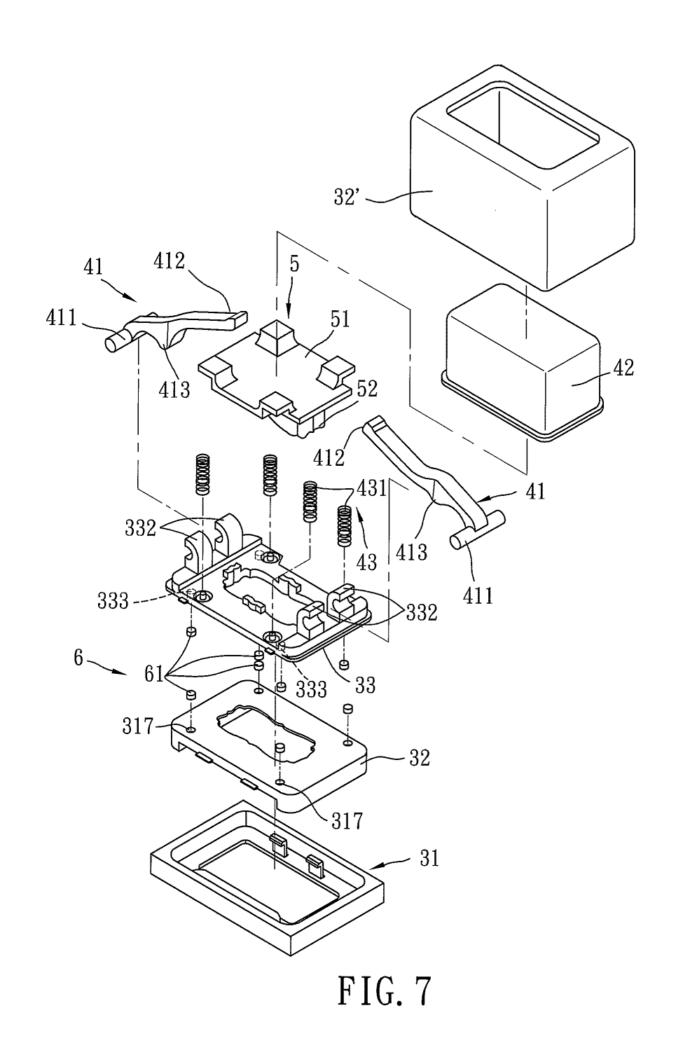

FIG. 7 illustrates the second preferred embodiment of the punching device 300 according to this invention. The second preferred embodiment differs from the previous embodiment in that the supporting part 33 is magnetically connected to the die part 32 through a magnetic unit 6.

In this embodiment, the magnetic unit 6 includes a plurality of magnets 61. Each of the supporting part 33 and the die part 32 has a periphery formed with a plurality of recesses 333, 317 for receiving respective ones of the magnets 61, thereby permitting secure connection between the supporting part 33 and the die part 32.

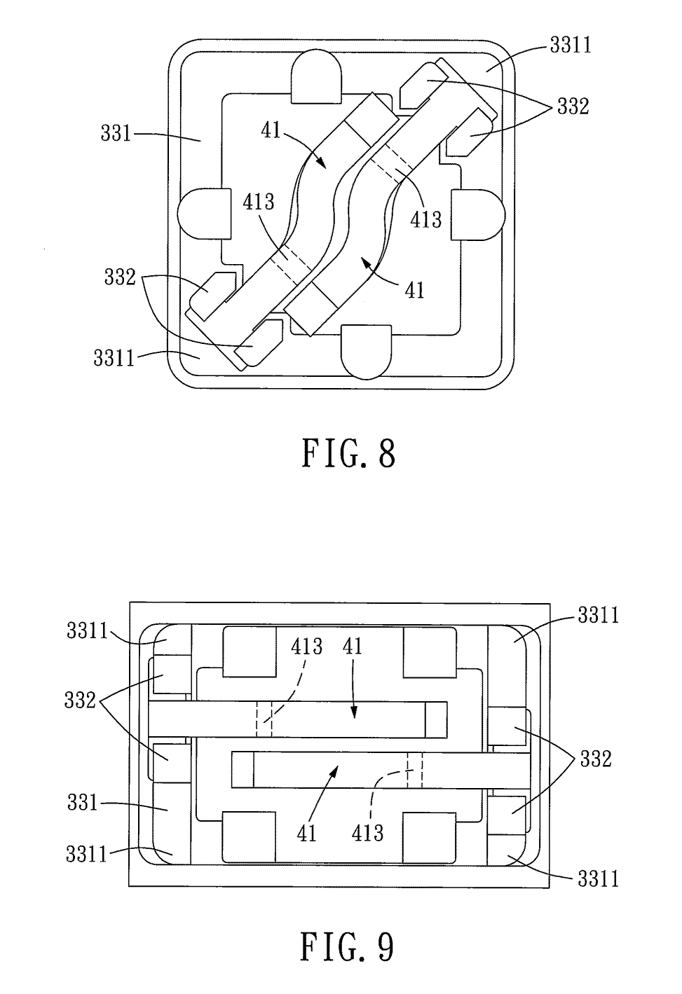

FIG. 8 illustrates the third preferred embodiment of the punching device 300 according to this invention. The third preferred embodiment differs from the first preferred embodiment in that the pivot seats 332 are disposed at two diagonal ones of the corners 3311, respectively.

FIG. 9 illustrates the fourth preferred embodiment of the punching device 300 according to this invention. The fourth preferred embodiment differs from the first preferred embodiment in that the pivot seats 332 are offset from each other in the transverse direction (T) and that each of the driving levers 41 is straight.

With the inclusion of the two driving levers 41 in the punching device 300 and by disposing the driving protrusions 413 of the driving levers 41 in a symmetrical manner with respect to the vertical axis (Z), the contact between the driving protrusion 413 of each of the driving levers 41 and the punch head 51 is no longer needed to be located on the vertical axis (Z) and can be offset from the vertical axis (Z) without causing the aforesaid imbalance problem to the punch unit 5, and the pivot end 411 and the driving protrusion 413 of each of the driving levers 41 can be disposed as close to each other as possible, i.e., the distance between the pivot end 411 and the driving protrusion 413 can be reduced, which, in turn, permits a reduction in the distance between the pressing end 412 and the pivot end 411 according to the lever principle without increasing the force acted on the pressing member 42 and required to punch the sheet, thereby achieving the goal of reducing the size of the punching device 300. In addition, since the force is acted on the pressing member 42 which is located on the vertical axis (Z) that passes through a center of gravity of the punching device 300, the punching device 300 is more stable as compared to the conventional punching device 200 (see FIG. 2) which tends to flip over when the pressing lever 25 of the punching device 200 is pressed.

With the invention thus explained, it is apparent that various modifications and variations can be made without departing from the spirit of the present invention.

What is claimed is:

1. A punching device for cutting a sheet, comprising:
a base unit including a supporting part having two opposite pivot seats, and a die part connected to said supporting part for supporting the sheet thereon;
a punch unit including a punch that is disposed between said pivot seats, said punch unit being supported movably on said base unit so that said punch is slidable against said die part along a vertical axis substantially perpendicular to the sheet for cutting the sheet; and
a pressing unit including two driving levers, each of which has a pivot end pivoted to a respective one of said pivot seats, a pressing end opposite to said pivot end, and a driving protrusion disposed between said pivot end and said pressing end and protruding therefrom toward said punch unit, the vertical axis being disposed between said driving protrusions of said driving levers, said driving protrusions of said driving levers being disposed in asymmetrical manner with respect to the vertical axis and being rotatable relative to said base unit to press against said punch unit to drive movement of said punch unit along the vertical axis toward said base unit for cutting the sheet when said pressing ends of said driving levers are pressed to move toward said base unit.

2. The punching device of claim 1, wherein said supporting part further has a frame portion that is generally rectangular in shape, that has four corners, and that defines a frame hole for extension of said punch therethrough, each of said pivot seats being disposed between two adjacent ones of said corners.

3. The punching device of claim 1, wherein said pressing unit further includes a pressing member seated on said pressing ends of said driving levers for pressing said pressing ends of said driving levers.

4. The punching device of claim 3, further comprising a cap mounted on said base unit for receiving said driving levers, said punch unit and said supporting part therein, and formed with a top opening for extension of said pressing member therethrough.

5. The punching device of claim 1, further comprising an urging unit for restoring said punch unit to its original position.

6. The punching device of claim 5, wherein said supporting part cooperates with said die part to define a gap therebetween for extension of the sheet therein, said urging unit extending between and abutting against said supporting part and said punch unit.

7. The punching device of claim 6, further comprising a magnetic unit, said supporting part being magnetically connected to said die part by said magnetic unit.

8. The punching device of claim 7, wherein said magnetic unit includes a plurality of magnets, each of said supporting part and said die part being formed with a plurality of recesses, said magnets being received respectively within said recesses in said supporting part and said die part.

9. The punching device of claim 1, wherein said supporting part further has a frame portion that is generally rectangular in shape, that has two diagonal corners, and that defines a frame hole for extension of said punch therethrough, said pivot seats being disposed at said diagonal corners, respectively.
